(19) United States
(12) Patent Application Publication
(10) Pub. No.: US 2010/0151743 A1
(43) Pub. Date: Jun. 17, 2010

(54) ELECTRICAL ADAPTER

(75) Inventors: YI ZHOU, Shenzhen (CN); XIAN-KUI SHI, Shenzhen (CN); CHUNG-YEN YANG, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/635,722

(22) Filed: Dec. 11, 2009

(30) Foreign Application Priority Data
Dec. 11, 2008 (CN) 200820303304.5

(51) Int. Cl. H01R 25/00

(52) U.S. Cl. 439/651; 439/638

(57) ABSTRACT

An electrical adapter (100) comprises a first electrical connector (2) having a first insulative housing (21) and a plurality of first terminal sets (22) disposed in the first insulative housing (21); a second electrical connector (3) having a second insulative housing (31) and a plurality of second terminal sets (32) disposed in the second insulative housing (31). A printed circuit board (4) is disposed between the first and second electrical connector (2, 3) and respectively electrically and mechanically connected to the first and second terminal sets (22, 32). And a cable (5) has an end electrically connected to the printed circuit board (4) and another end for electrically connected to another electrical connector.

### FIELD OF THE INVENTION

The present invention relates to electrical adapter, particularly to an electrical adapter for connecting storage devices such as hard disks, DVD, and CD-RW drives to the PC motherboard.

### DESCRIPTION OF PRIOR ART

In the recent years, more and more electrical adapters are widely used in PC for connecting storage devices such as hard disks, DVD, and CD-RW drives to the PC motherboard. Generally, an electrical adapter can only interconnect with two electrical connectors. U.S. Pat. No. 6,663,434 issued to Wu on Dec. 16, 2003 disclose an electrical adapter including a female portion and a male portion adapted to be assembled. The female portion comprises a first housing defining two slots and a plurality of first contacts. A plurality of first passageways is defined in the first housing and communicates with the slots. The first contacts are retained into the first passageways. The male portion comprises a second housing having a pair of tongues and a plurality of second contacts. The tongues define a plurality of positioning slits for receiving the second contacts. Each of the first contacts is aligned and cooperated with a corresponding second contact to form a transmission path. However, sometimes we need an electrical adapter for interconnecting three or more electrical connectors, so the electrical adapter disclosed in the U.S. Pat. No. 6,663,434 can not meet the above requirement.

U.S. Pat. No. 6,887,108 to Wu on Feb. 5, 2004 discloses an electrical adapter including a serial advanced technology attachment (Serial ATA) receptacle connector, a single connector attachment 2 (SCA2) plug connector, a printed circuit board and a pair of covers. The serial ATA receptacle connector and the SCA2 plug connector are respectively electrically and mechanically connected to the printed circuit board. The printed circuit board performs the functions of signal transmission and conversion between the serial ATA receptacle connector and the SCA2 plug connector. The electrical adapter interconnects the SCA2 interface with the serial ATA interface. However, the electrical adapter disclosed in the U.S. Pat. No. 6,887,108 also only can interconnecting two electrical connectors so that the electrical adapter can not meet the requirements of interconnecting with three or more electrical connectors.

As discussed above, an improved electrical adapter overcoming the shortages of existing technology is needed.

### SUMMARY OF THE INVENTION

Accordingly, an object of the present invention is to provide an electrical adapter for interconnecting two or more electrical connectors.

In order to achieve the above-mentioned objects, an electrical adapter comprises a first electrical connector having a first insulative housing and a plurality of first terminal sets disposed in the first insulative housing; a second electrical connector having a second insulative housing and a plurality of second terminal sets disposed in the second insulative housing. A printed circuit board is disposed between the first and second electrical connector and respectively electrically and mechanically connected to the first and second terminal sets. And a cable has an end electrically connected to the printed circuit board and another end for electrically connected to another electrical connector.

Other objects, features and advantages of the invention will be apparent from the following detailed description taken in connection with the accompanying drawings.

### BRIEF DESCRIPTION OF THE DRAWINGS

FIG. 1 is a perspective view of an electrical adapter in accordance with the present invention;

FIG. 2 is similar to FIG. 1, but viewed from another aspect;

FIG. 3 is a partial assembled, perspective view of the electrical adapter of FIG. 2;

FIG. 4 is a partial assembled, perspective view of the electrical adapter without a cover of FIG. 2;

FIG. 5 is another partial assembled, perspective view of the electrical adapter without a cover of FIG. 1; and

FIG. 6 is similar to FIG. 3, but viewed from another aspect.

### DETAILED DESCRIPTION OF PREFERRED EMBODIMENTS

Reference will now be made to the drawing figures to describe the present invention in detail.

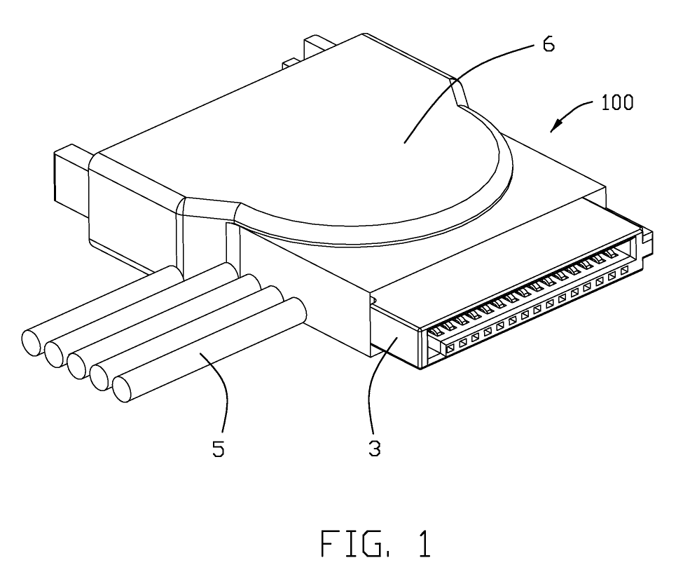

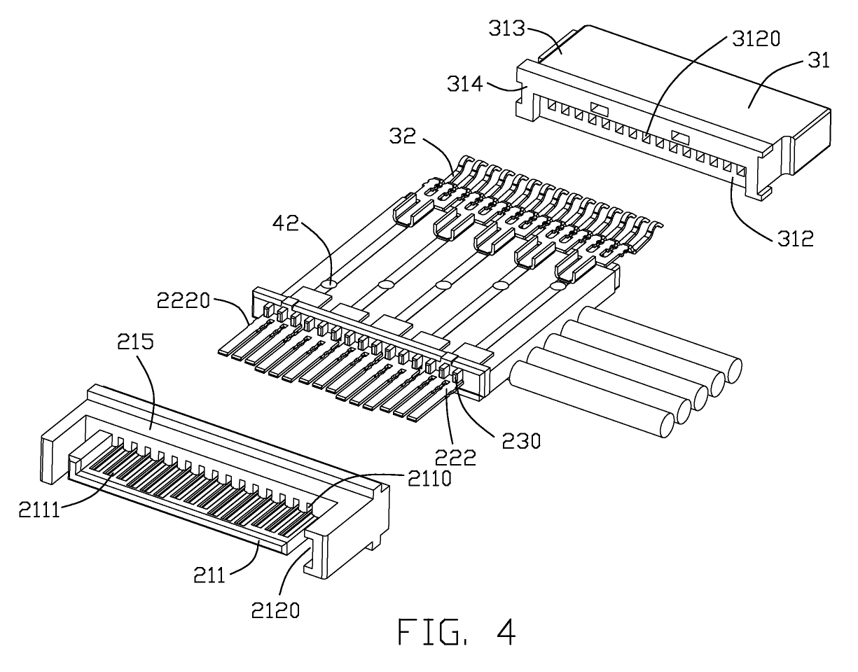

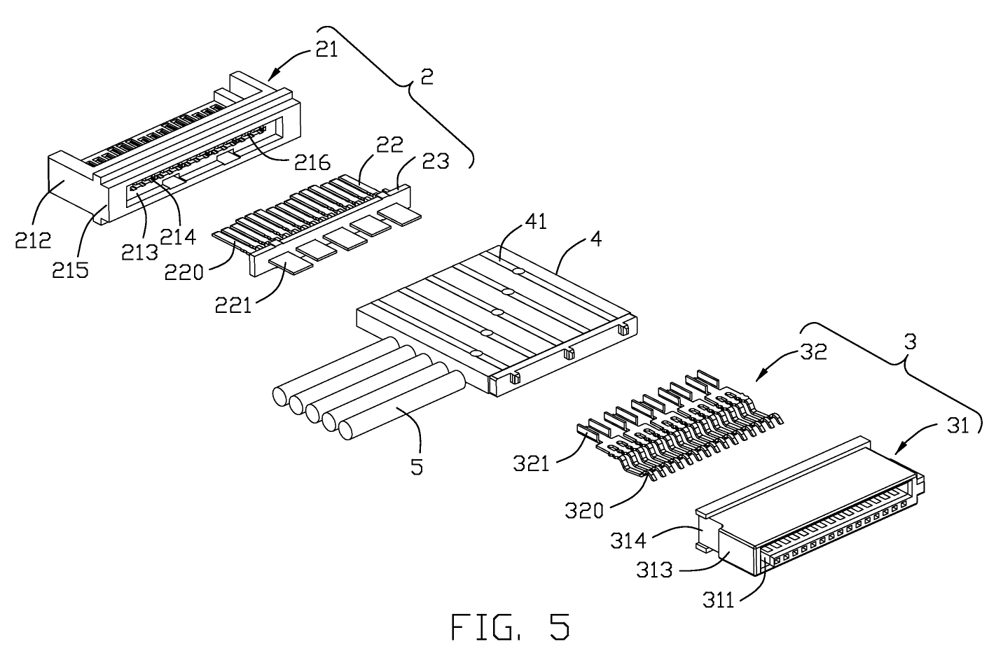

Referring to FIGS. 1 to 5, an electrical adapter in accordance with the present invention, generally designated 100, is adapted for mating with three or more complementary connectors (not shown). The electrical adapter 100 includes a first electrical connector 2, a second electrical connector 3, a printed circuit board 4 electrically and mechanically connected to the first and second electrical connectors 2, 3, a plurality of wires 5 electrically connected to the printed circuit board 4 and a cover 6 overmolding around the printed circuit board 4, a portion of the first and second electrical connector 2, 3 and a portion of the plurality of wires 5.

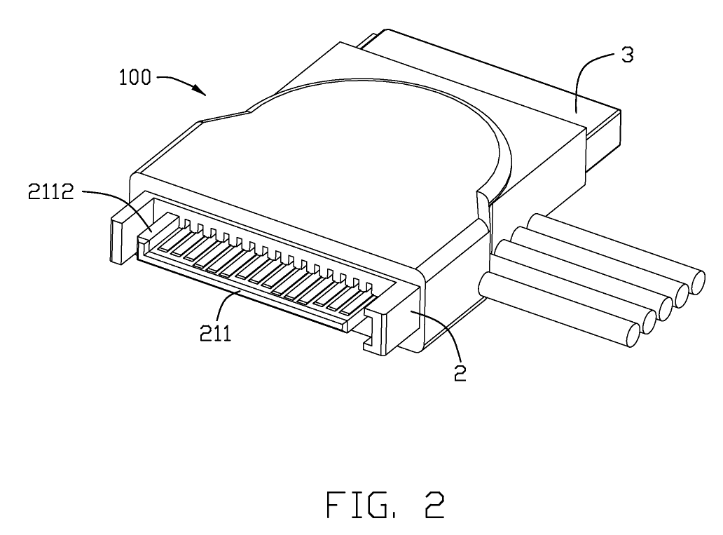

Referring to FIGS. 2 to 5, the first electrical connector 2 is a SATA (Serial Advanced Technology Attachment) plug connector, it includes a first insulative housing 21, a plurality of first terminal sets 22 received into the first insulative housing 21 and a spacer 23 integrated with the plurality of first terminal sets 22 and attached to a rear end of the first insulative housing 21. The first insulative housing 21 defines a base portion 215, a tongue portion 211 extending forward from a front surface of the base portion 215, and a pair of arms 212 extending forward from the front surface of the base portion 215 and disposed at two sides of the tongue portion 211. A groove 2120 is formed on an inner surface of one arm 212 for cooperating with a portion of the complementary connector. The tongue portion 211 has a horizontal portion (not figured) and a vertical portion 2112 extending upward from one side of the horizontal portion. The tongue portion 211 defines a plurality of first terminal receiving slots 2111 formed on a top surface thereof and extending along a mating direction. The plurality of first terminal receiving slots 2111 can be divided into five groups, each group has three first terminal receiving slots 2111. Two adjacent groups of the first terminal receiving slots 2111 have different lengths. Two spaced groups of the first terminal receiving slots 2111 have a same length. The base portion 215 of the first insulative housing 21 defines a plurality of channels 2110 formed on a front surface thereof and communicated with the corresponding first terminal receiving slots 2111 in a longitudinal direction. The base portion 215 of the first insulative housing 21 further defines a receiving cavity 213 formed on a rear surface thereof and communicated with the plurality of channels 2110. A plurality of protruding blocks 216 are formed on an inner surface of the receiving cavity 213. Two adjacent protruding blocks 216 are spaced by a gap 214.

Each first terminal set 22 has a soldering portion 221, three retention portions 222 extending forwardly from the soldering portion 221 and three mating portions 220 extending forwardly from corresponding retention portions 222. Each retention portion 222 forms a plurality of barbs 2220 on opposite sides thereof for retaining the first terminal set 22 to the insulative housing 21. The three mating portions 220 of each first terminal set 22 can all be received into the corresponding terminal receiving slots 2111. The spacer 23 defines a plurality of slits (not figured) for the corresponding soldering portion 221 of the first terminal set 22 passing through. And, the spacer 23 further defines a plurality of protrusions 320 extending forward from a front surface of the spacer 23. The spacer 23 can be received into the receiving cavity 213 and the plurality of protrusions 320 formed on the spacer 23 can be received into the corresponding channels 2110.

Referring to FIGS. 1, and 3 to 5, the second electrical adapter 3 is a SATA (Serial Advanced Technology Attachment) receptacle connector, it includes a second insulative housing 31 and a plurality of second terminal sets 32. The second insulative housing 31 defines a mating portion 313 having a L-shape receiving room 311 therein and a rear portion 314 having a recess 312 formed on a rear surface thereof. A plurality of second terminal receiving slots 3120 are formed on an inner surface of the receiving room 311 and communicated with the recess 312 in a longitudinal direction. The second terminal receiving slots 3120 also communicate with the receiving room 311.

Each second terminal set 32 has a fork-shaped configuration and comprises a base portion 323, three retention portions 322 extending forwardly from the base portion 323, three mating portions 320 extending forwardly from corresponding retention portions 322, and a U-shaped soldering portion 321 extending rearwardly from a rear edge of the base portion 323.

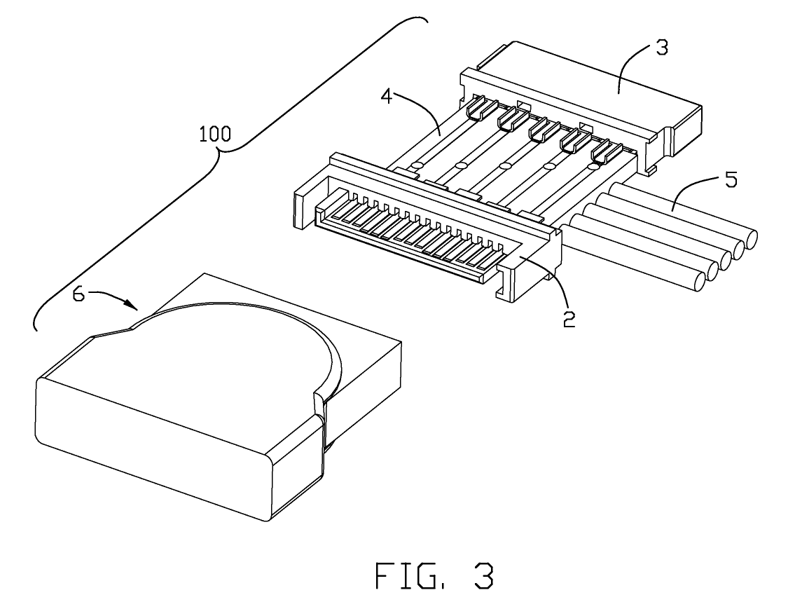

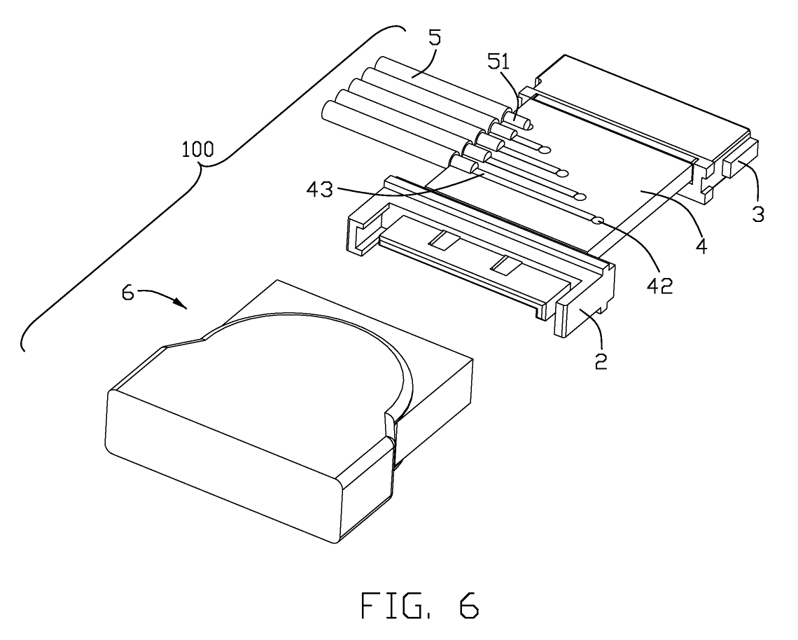

Referring to FIGS. 3 to 6, the printed circuit board 4 is generally in a rectangular shape. The printed circuit board 4 has a top surface and a bottom surface opposite to the top surface. A plurality of first conductive traces 41 are formed on the top surface of the printed circuit board 4 and paralleled with each other. The plurality of first conductive traces 41 extends along a lengthwise direction of the printed circuit board 4. A plurality of second conductive traces 42 are formed on the bottom surface of the printed circuit board 4 and paralleled with each other. The plurality of second conductive traces 43 extends along a widthwise direction of the printed circuit board 4. The printed circuit board 4 further defines a plurality of holes 42 extending from the bottom surface to the top surface thereof and respectively located at an intersection between a first conductive trace 41 and a second conductive trace 43. Each first conductive trace 41 is respectively electrically connected to a second conductive trace 43 through a corresponding hole 42. And the plurality of holes 42 are staggered with each other in a lengthwise and widthwise direction of the printed circuit board 4. In addition, each wire 5 has a conductor 51 therein which can be electrically connected to a corresponding second conductive trace 43. The printed circuit board 4 can performs the functions of power transmission and conversion, allowing the electrical adapter 100 to electrically interconnect with a SATA plug connector and SATA receptacle connector. Each wire 5 has one end electrically connected to the printed circuit board 4 and another end extending out of the cover 6 for electrically connecting to another electrical connector (not shown).

In assembly, as shown in FIGS. 1 to 6, integrating the first terminal sets 22 and the spacer 23 together, and then assembling the first terminal sets 22 and the spacer 23 to the first insulative housing together. Thus, the mating portions 220 of the plurality of first terminal sets 22 of the first electrical connector 2 are received into the corresponding first terminal receiving slots 2111 of the first insulative housing 21, the retention portions 222 of the plurality of first terminal sets 22 are received into and interfered with the corresponding channels 2110, so the plurality of first terminal sets 22 are retained to the first insulative housing 21. And the soldering portions 221 of the plurality of the first terminal sets 22 pass through the slits of the spacer 23 and are beyond a rear surface of the insulative housing 21.

Subsequently, assembling a plurality of second terminal sets 32 to the second insulative housing 31. Thus, three mating portions 320 of the second terminal sets 32 are received into the second terminal receiving slots 3120, and the three retention portions 322 are interfered with the second terminal receiving slots 3120. So, the plurality of second terminal sets 32 are retained to the second insulative housing 31.

Then, soldering the soldering portions 221 of the first terminal sets 22 respectively to one side of the first conductive traces 41 and soldering the soldering portions 321 of the second terminal sets 32 to another side of the first conductive traces 41. Thus, the first and second electrical connectors 2, 3 are respectively electrically and mechanically connected to the printed circuit board 4.

Then, soldering the conductors 51 of the wires 5 to the corresponding second conductive traces 43 of printed circuit board 4. The wires 5 are vertical with the printed circuit board 4.

At last, overmolding a cover 6 around the printed circuit board 4, a portion of the first and second electrical connector 2, 3 and a portion of the plurality of wires 5.

Through the above assembling steps, the electrical adapter 100 is accomplished. In addition, it should be noted that one end of the wires 5 are connected to the printed circuit board 4, and another end of the wires 5 can be connected to a third connector (not shown). Thus, the electrical adapter 100 can adapter three electrical connectors. If more wires (not shown) are electrically connected to the printed circuit board 4, thus, the wires also can connect with a fourth electrical connector. So the electrical adapter 100 can adapter more than three electrical connectors.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. An electrical adapter, comprising:
a first electrical connector having a first insulative housing and a plurality of first terminal sets disposed in the first insulative housing;
a second electrical connector having a second insulative housing and a plurality of second terminal sets disposed in the second insulative housing;
a printed circuit board disposed between the first and second electrical connector and respectively electrically and mechanically connected to the first and second terminal sets; and
a cable having an end electrically connected to the printed circuit board and another end for electrically connecting to another electrical connector.

2. The electrical adapter as recited in claim 1, wherein the first insulative housing defines a base portion, a tongue portion extending forward from a front surface of the base portion and a pair of arms extending forward from the front surface of the base portion and disposed at two sides of the tongue portion.

3. The electrical adapter as recited in claim 2, wherein the base portion of the first insulative housing defines a plurality of channels formed on a front surface thereof and a receiving cavity formed on a rear surface thereof and communicated with the plurality of channels, the tongue portion defines a plurality of terminal receiving slots communicated with the corresponding channels in a longitudinal direction.

4. The electrical adapter as recited in claim 3, wherein each first terminal set defines three retention portions respectively disposed into the corresponding channels, three mating portions extending forward from corresponding retention portions and respectively received into the corresponding terminal receiving slots, and a soldering portion extending rearward form the retention portions and beyond a rear surface of the base portion.

5. The electrical adapter as recited in claim 1, wherein the second electrical connector defines a second insulative housing having a mating portion with a receiving room therein and a rear portion having a recess formed on a rear surface thereof.

6. The electrical adapter as recited in claim 5, wherein a plurality of second terminal receiving slots are formed on an inner surface of the receiving room and communicated with the recess in a longitudinal direction.

7. The electrical adapter as recited in claim 5, wherein each second terminal set defines a base portion, three retention portions extending forwardly from the base portion, three mating portions extending forward from corresponding retention portions, and a soldering portion extending rearward from a rear edge of the base portion.

8. The electrical adapter as recited in claim 1, wherein the printed circuit board defines a plurality first and second conductive traces respectively formed on a top and a bottom surface thereof, and each first and second terminal set respectively defines a rear portion electrically connected to a corresponding first conductive trace, and the cable defines a plurality of conductors electrically connected to the corresponding second conductive traces.

9. The electrical adapter as recited in claim 8, wherein the printed circuit board defines a plurality of holes respectively located at an intersection between a first conductive trace and a second conductive trace, and one first conductive trace is electrically connected with the second conductive trace through the hole.

10. The electrical adapter as recited in claim 1, wherein the electrical adapter further comprises a cover overmolding around the printed circuit board, a portion of the first and second electrical connector and a portion of the plurality of wires.

11. An electrical adapter for interconnecting with two or more electrical connectors, comprising:
a printed circuit board;
a first electrical connector electrically and mechanically connected to one end of printed circuit board;
a second electrical connector electrically and mechanically connected to another end of printed circuit board;
a cover surrounding the printed circuit board and a rear portion of the first and second electrical connectors; and
a plurality of wires electrically connected to the printed circuit board and extending out of the cover for electrically connecting to another connector.

12. The electrical adapter as recited in claim 11, wherein the first electrical connector is a SATA plug connector and the second electrical connector is a SATA receptacle connector.

13. The electrical adapter as recited in claim 11, wherein the first electrical connector defines a first insulative housing and a plurality of first terminals disposed in the first insulative housing, the second electrical connector defines a second insulative housing and a plurality of second terminals disposed in the second insulative housing.

14. The electrical adapter as recited in claim 13, wherein each first and second terminal respectively defines a soldering portion electrically connected to two opposite ends of the printed circuit board.

15. The electrical adapter as recited in claim 13, wherein the printed circuit board defines a plurality of first and second conductive traces respectively formed on a top and bottom surface, the first terminals are electrically connected to the first conductive traces, the wires are electrically connected to the second conductive traces.

16. The electrical adapter as claimed in claim 15, wherein the printed circuit board defines a plurality of holes respectively electrically connected with the first and second traces.

17. An electrical connector assembly comprising:
a printed circuit board defining opposite first and second ends with a middle area therebetween;
a first connector mechanically and electrically connected to the first end and defining a first direction for mating with a first complementary connector;
a second connector mechanically and electrically connected to the second end and defining a second direction, opposite to said first mating direction, for mating with a second complementary connector;
a plurality of wires mechanically and electrically connected to said middle area; wherein
said wires extend in a third direction perpendicular to both said first direction and said second direction.

18. The electrical connector assembly as claimed in claim 17, wherein said wires are side by side arranged in a plane parallel to said printed circuit board.

19. The electrical connector assembly as claimed in claim 18, wherein said printed circuit board is enclosed in a cover defining main upper and bottom faces connected to each other via four side faces through which said first connector, said second connector and said wires extend outwardly along said first direction, said second direction and said third direction, respectively.

20. The electrical connector assembly as claimed in claim 18, wherein connection ends of said wires at the printed circuit board are arranged in an oblique direction so as to correspond to traces on the printed circuit board, which electrically connect the first connector and the second connector along the first direction.
